(19) United States
(12) Patent Application Publication
(10) Pub. No.: US 2007/0009166 A1
(43) Pub. Date: Jan. 11, 2007

(54) Scalable system for discrete cosine transform and method thereof

(76) Inventor: Chi-Cheng Ju, Hsinchu City (TW)

Correspondence Address: Hoffman, Warnick & D'Alessandro LLC, Three E-Comm Square, Albany, NY, 12207, US

(21) Appl. No.: 11/174,994

(22) Filed: Jul. 5, 2005

(51) Int. Cl. G06K 9/36

(52) U.S. Cl. 382/250

(57) ABSTRACT

A data processing system for transforming an input matrix into at least one specified column of discrete cosine transform (DCT) coefficients in an output matrix via a DCT procedure is provided. The data processing system includes an input data control unit and a basic operation unit. The input data control unit is used for receiving the input matrix, generating a first transformation control signal, and outputting the input matrix with the first transformation control signal. The first basic operation unit is used for receiving the first transformation control signal and the input matrix outputted from the first input data control unit, and for transforming the input matrix into the DCT coefficients of at least one specified column, which corresponds to the first transformation control signal, in the output matrix via the DCT procedure.

### CROSS REFERENCE

This application is related to the pending patent application Ser. No. 10/838,247, entitled “Scalable System for Inverse Discrete Cosine Transform and Method Thereof,” filed on May 5, 2004 and assigned to the same Assignee as the present application.

### BACKGROUND OF THE INVENTION

1. Field of the Invention

The present invention relates to a data processing system and method thereof. More specifically, the present invention relates to a data processing system and method thereof for performing discrete cosine transform (DCT) procedures.

2. Description of the Prior Art

The digital video codecs of prior arts usually utilize discrete cosine transform (DCT) procedures to compress digital data. According to some international image encoding/decoding standards (for example, MPEG1, MPEG2, and MPEG4), each picture is first divided into N×N pixel blocks. Generally, N is equal to 8. Then, in the image encoding procedure, block data x_{h,v} in time domain is transformed into DCT coefficients y_{k,l} in frequency domain with DCT procedures.

In a general encoding procedure, a digital image codec performs a 8-8 DCT procedure on a data flow. The equation of the 8-8 DCT procedure is:

$${y}_{k , l} = {\sum }_{v = 0}^{7} {\sum }_{h = 0}^{7} c ( k ) c ( l ) * {x}_{h , v} * COS ( \frac{( 2 h + 1 )}{16} k π ) * COS ( \frac{( 2 v + 1 )}{16} l π ) ,$$

wherein

$$c ( 0 ) = \frac{1}{2 \sqrt{2}} , c ( i ) = 1 / 2 ;$$

i is an integer ranging from 1 to 7.

Please refer to the U.S. Pat. No. 5,565,921 for detailed encoding processes of DCT procedures of compressing digital images in digital image codecs.

The prior arts use a conventional row column decomposition method to divide a 2-D DCT operation into two 1-D DCT operations, a first DCT operation and a second DCT operation. In the digital image codecs of prior arts, before performing the second 1-D DCT operation, all the outcomes of the first 1-D DCT operation must be obtained. This waiting period prolongs the time of compressing digital images. Besides, prior arts further need a large buffer for temporarily storing all the outcomes of the first 1-D DCT operation so the costs of digital image codecs are increased.

As mentioned in “Case study on discrete cosine transformation, 2D-DCT with linear processor arrays” reported by Ullrich Totzek, Fred Matthiesen, and Michael Boehner, etc. on EEC SPRITE research report A.2.c/Siemens/Y2m6/4, Jun. 1, 1990, this prior art enables a digital image codec to perform the second 1-D DCT operation on partial outcomes of the first 1-D DCT operation when the first 1-D DCT operation is still processing other outcomes. Since the second 1-D DCT operation can be performed without waiting for the completion of the first 1-D DCT operation, the needed time of calculation can be substantially reduced.

However, the hardware architecture of the above prior art lacks scalability. Since the demand on the throughput of DCT operation varies in different systems, if the throughput of a DCT operation is requested to be further risen, the hardware of the above prior art must be redesigned. Redesigning not only wastes designing resources, but also extends design cycles, and might fail to meet time-to-market requirements.

Accordingly, the major objective of the present invention is to provide a scalable system for DCT and method thereof to solve the problems of the prior arts.

### SUMMARY OF THE INVENTION

The objective of the present invention is to provide a data processing system and method thereof to solve the drawbacks of the prior arts.

The other objective of the present invention is to provide a DCT system and method thereof which possess scalability property and can effectively shorten the process time of compressing digital images.

According to the data processing system and method of this invention, a first transformation control signal is first generated and transferred together with an input matrix X to at least one basic operation unit (BOU). The BOU receiving the first transformation control signal generates a new transformation control signal with a transformation control signal updating procedure. The new transformation control signal is then transferred together with the input matrix X to the next BOUs. Every transformation control signal corresponds to at least one specific column of an output matrix Y. The procedure of generating new transformation control signals is repeated until every column of the output matrix Y is assigned to a corresponding BOU. Each BOU performs a DCT procedure according to respectively received transformation control signals.

The data processing method of the present invention can solve the problem that the data processing systems of the prior arts are not scalable. According to different requirements on the throughput of DCT procedures in different systems, the present invention can integrate a plurality of BOUs, without redesigning the hardware. In the present invention, a plurality of BOUs can be enabled to perform DCT procedures at the same time, thus the total time of calculation is shorten. The present invention also solves the problem that the second DCT procedure must wait for all the outcomes of the first DCT procedure. The present invention can reduce the capacity requirement for the buffer memory of prior arts, too. Furthermore, the present invention decreases the operation time and the necessary hardware circuits with sharing operation procedure; hence image processing time and the cost of hardware are both substantially reduced.

The advantage and spirit of the invention may be understood by the following recitations together with the appended drawings.

### BRIEF DESCRIPTION OF THE APPENDED DRAWINGS

FIG. 1 is a schematic diagram of a data processing system of one preferred embodiment according to the present invention.

FIG. 2 is a flowchart of the input data control method of the present invention.

FIG. 3 shows the relationships between the transformation control signals and the column numbers of columns in the output matrix Y generated by each BOU 110 in one preferred embodiment, which includes only one BOU, according to this invention.

FIG. 4 shows the relationships between the transformation control signals and the column numbers of columns in the output matrix Y generated by each BOU 110 in one preferred embodiment, which includes two BOUs, according to this invention.

FIG. 5 shows the relationships between the transformation control signals and the column numbers of columns in the output matrix Y generated by each BOU 110 in one preferred embodiment, which includes eight BOUs, according to this invention.

FIG. 6 is a schematic diagram of the operation method of the data processing system shown in FIG. 5.

FIG. 7 is a block diagram of the first processing unit shown in FIG. 1.

FIG. 8 is another block diagram of the first processing unit shown in FIG. 1.

### DETAILED DESCRIPTION OF THE INVENTION

The data processing system and method thereof according to this invention are applied in digital codecs of digital image devices. The data processing system and method transform an input matrix X, which includes a plurality of data, into an output matrix, which includes a plurality of discrete cosine transform (DCT) coefficients, via a DCT procedure. For the convenience of description, the input matrix is represented as matrix X, and the output matrix is represented as matrix Y in the following specification.

According to one preferred embodiment of this invention, the DCT procedure is an 8-8 DCT procedure. The input matrix X has 8 rows and 8 columns of data, x_{h,v} (h=0˜7, v=0˜7). The input matrix X is represented in the following form:

$$X = [ \begin{matrix}{x}_{0 , 0} & {x}_{0 , 1} & {x}_{0 , 2} & {x}_{0 , 3} & {x}_{0 , 4} & {x}_{0 , 5} & {x}_{0 , 6} & {x}_{0 , 7} \\ {x}_{1 , 0} & {x}_{1 , 1} & {x}_{1 , 2} & {x}_{1 , 3} & {x}_{1 , 4} & {x}_{1 , 5} & {x}_{1 , 6} & {x}_{1 , 7} \\ {x}_{2 , 0} & {x}_{2 , 1} & {x}_{2 , 2} & {x}_{2 , 3} & {x}_{2 , 4} & {x}_{2 , 5} & 2 {x}_{2 , 6} & {x}_{2 , 7} \\ {x}_{3 , 0} & {x}_{3 , 1} & {x}_{3 , 2} & {x}_{3 , 3} & {x}_{3 , 4} & {x}_{3 , 5} & {x}_{3 , 6} & {x}_{3 , 7} \\ {x}_{4 , 0} & {x}_{4 , 1} & {x}_{4 , 2} & {x}_{4 , 3} & {x}_{4 , 4} & {x}_{4 , 5} & {x}_{4 , 6} & {x}_{4 , 7} \\ {x}_{5 , 0} & {x}_{5 , 1} & {x}_{5 , 2} & {x}_{5 , 3} & {x}_{5 , 4} & {x}_{5 , 5} & {x}_{5 , 6} & {x}_{5 , 7} \\ {x}_{6 , 0} & {x}_{6 , 1} & {x}_{6 , 2} & {x}_{6 , 3} & {x}_{6 , 4} & {x}_{6 , 5} & {x}_{6 , 6} & {x}_{6 , 7} \\ {x}_{7 , 0} & {x}_{7 , 1} & {x}_{7 , 2} & {x}_{7 , 3} & {x}_{7 , 4} & {x}_{7 , 5} & {x}_{7 , 6} & {x}_{7 , 7}\end{matrix} ]$$

The output matrix Y has 8 rows and 8 columns of DCT coefficients, y_{k,l} (k=0˜7, l=0˜7). The output matrix Y is represented in the following form:

$$Y = [ \begin{matrix}{y}_{0 , 0} & {y}_{0 , 1} & {y}_{0 , 2} & {y}_{0 , 3} & {y}_{0 , 4} & {y}_{0 , 5} & {y}_{0 , 6} & {y}_{0 , 7} \\ {y}_{1 , 0} & {y}_{1 , 1} & {y}_{1 , 2} & {y}_{1 , 3} & {y}_{1 , 4} & {y}_{1 , 5} & {y}_{1 , 6} & {y}_{1 , 7} \\ {y}_{2 , 0} & {y}_{2 , 1} & {y}_{2 , 2} & {y}_{2 , 3} & {y}_{2 , 4} & {y}_{2 , 5} & {y}_{2 , 6} & {y}_{2 , 7} \\ {y}_{3 , 0} & {y}_{3 , 1} & {y}_{3 , 2} & {y}_{3 , 3} & {y}_{3 , 4} & {y}_{3 , 5} & {y}_{3 , 6} & {y}_{3 , 7} \\ {y}_{4 , 0} & {y}_{4 , 1} & {y}_{4 , 2} & {y}_{4 , 3} & {y}_{4 , 4} & {y}_{4 , 5} & {y}_{4 , 6} & {y}_{4 , 7} \\ {y}_{5 , 0} & {y}_{5 , 1} & {y}_{5 , 2} & {y}_{5 , 3} & {y}_{5 , 4} & {y}_{5 , 5} & {y}_{5 , 6} & {y}_{5 , 7} \\ {y}_{6 , 0} & {y}_{6 , 1} & {y}_{6 , 2} & {y}_{6 , 3} & {y}_{6 , 4} & {y}_{6 , 5} & {y}_{6 , 6} & {y}_{6 , 7} \\ {y}_{7 , 0} & {y}_{7 , 1} & {y}_{7 , 2} & {y}_{7 , 3} & {y}_{7 , 4} & {y}_{7 , 5} & {y}_{7 , 6} & {y}_{7 , 7}\end{matrix} ]$$

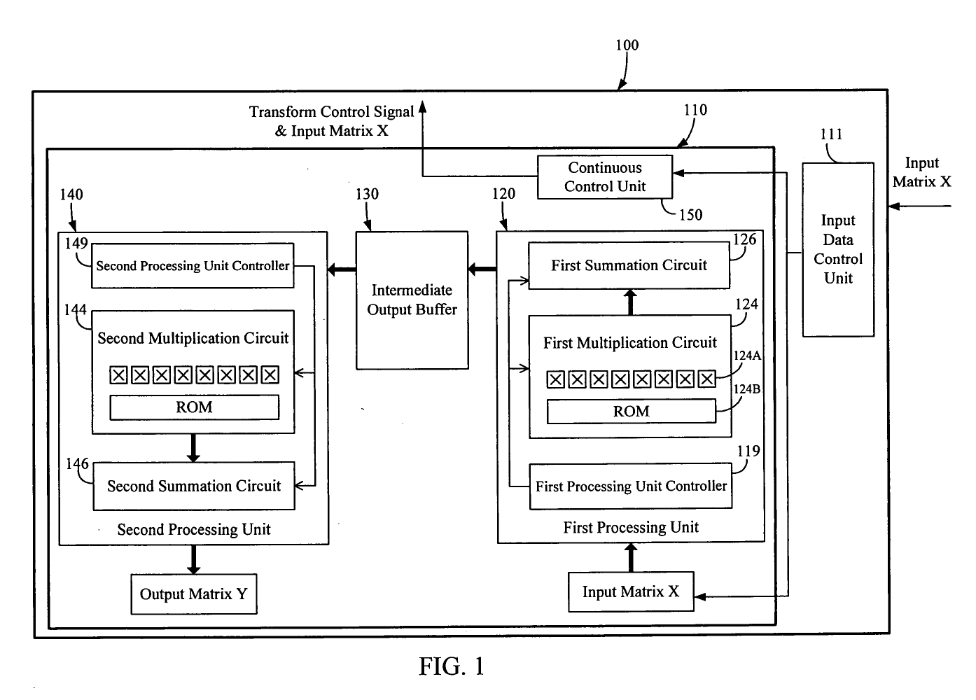

Please refer to FIG. 1. FIG. 1 shows the schematic diagram of a data processing system of one preferred embodiment according to the present invention. The data processing system 100 includes at least one basic operation unit (BOU) 110 and one input data control unit 111. The input data control unit 111 is used for generating transformation control signals and for outputting the input matrix X and the generated transformation control signals to the BOU 110. Every transformation control signal corresponds to one specific column of the output matrix Y. Each BOU 110 performs a DCT procedure and outputs one specified column of DCT coefficients relative the received transformation control signal at a time.

In the above embodiment, the transformation control signals are equal to the column numbers of the columns in the output matrix Y. For example, if the BOU 110 is appointed to generate the DCT coefficients of first column in the output matrix Y, the transformation control signal for the BOU 110 is 1. If the BOU 110 is appointed to generate the DCT coefficients of the first, third, and fifth columns in the output matrix Y, the transformation control signals for the BOU 110 are 1, 3, and 5.

When the data processing system 100 includes not only one BOU 110, the BOUs 110 are connected to each other. According to one preferred embodiment of the present invention, the BOUs 110 are cascaded to each other. Each BOU 110 is capable of connecting to more than one other BOUs 110 at the same time.

One of the BOUs 110 first receives the input matrix X and the transformation control signal from the input data control unit 111; it then generates at least one corresponding new transformation control signal, based on the received transformation control signal. The new transformation control signal is transferred together with the input matrix X to the following BOU 110. Each of the BOUs 110 generates the DCT coefficients in at least one specified column in the output matrix Y according to the respectively received transformation control signals.

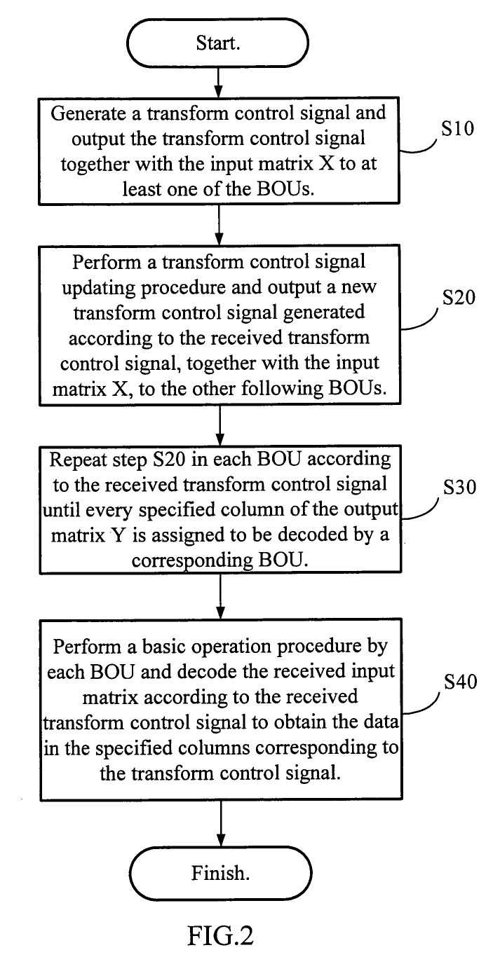

Please refer to FIG. 2. FIG. 2 is a flowchart of the input data control method of this present invention. The input data control method of the present invention includes the following steps.

Step S10 is generating a transformation control signal and outputting the transformation control signal together with the input matrix X to at least one BOU.

Step S20 is performing a transformation control signal updating procedure and outputting a new transformation control signal generated according to a received transformation control signal, together with the input matrix X, to the other following BOUs.

Step S30 is repeating step S20 in each BOU according to respective received transformation control signals until every column in the output matrix Y is assigned to be generated by a corresponding BOU.

Step S40 is performing a basic operation procedure and generating the DCT coefficients in the specified columns corresponding to respectively received transformation control signal in each BOU.

According to one embodiment of the present invention, the transformation control signal updating procedure in step S20 is respectively adding one to the column number of at least one specified column to obtain a new transformation control signal. For example, if the transformation control signal received by the BOU 110 is 1, the corresponding new transformation control signal is 2. If the transformation control signals received by the BOU 110 are 1, 3, and 5, respectively, the corresponding new transformation control signals are 2, 4, and 6.

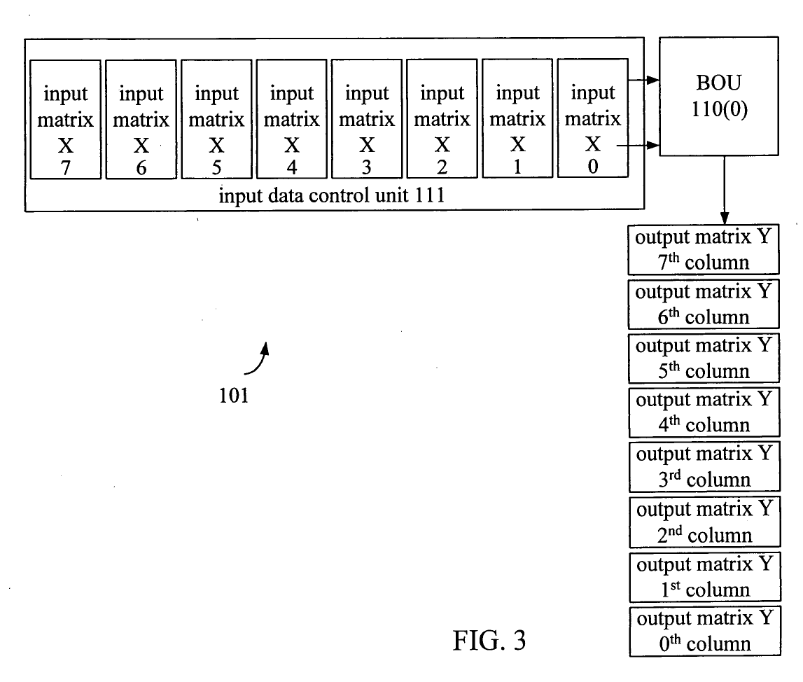

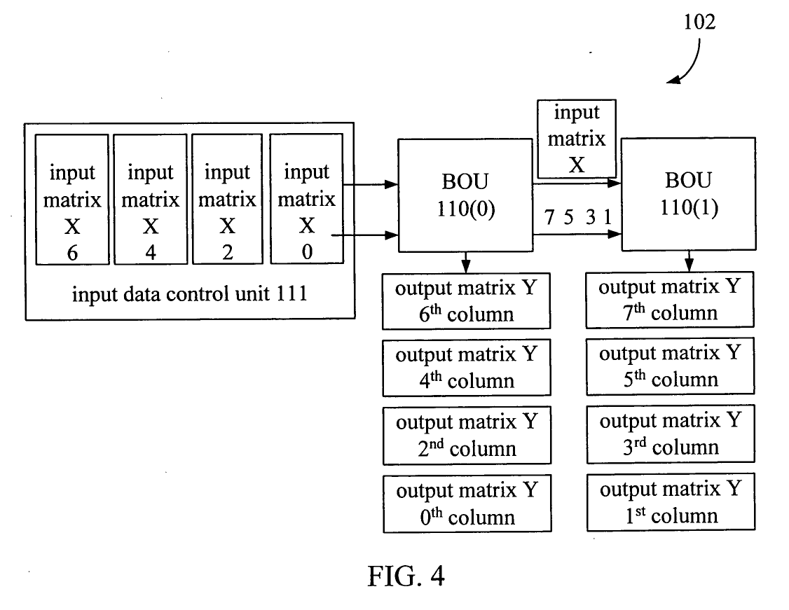

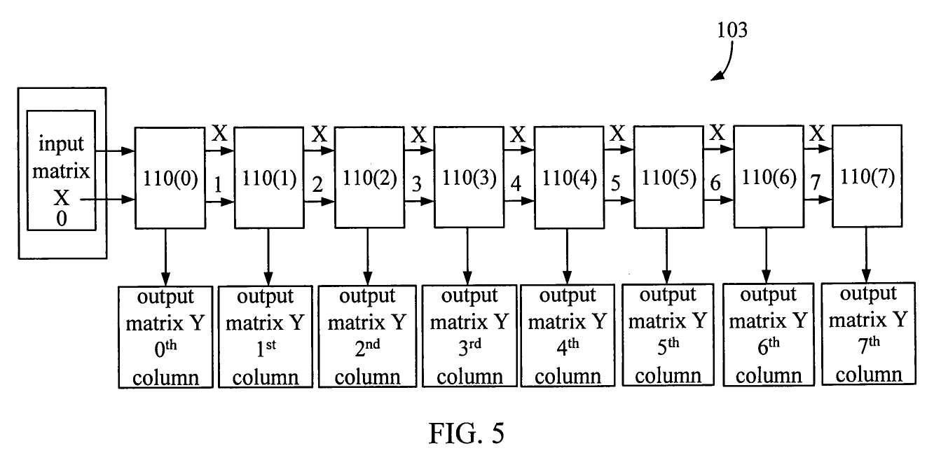

FIG. 3, FIG. 4, and FIG. 5 show the relationships between the transformation control signals and the column numbers of columns in the output matrix Y generated by each BOU 110 in three different embodiments according to this invention, respectively.

Please refer to FIG. 3. In this preferred embodiment, the data processing system 101 includes only one BOU, BOU 110(0). Because the output matrix Y has eight columns of DCT coefficients, the input data control unit 111 outputs the input matrix X to the BOU 110(0) for eight times. The input data control unit 111 also outputs a respective transformation control signal to the BOU 110(0) each time accompanying the input matrix X.

Whenever the BOU 110(0) receives the input matrix X, the BOU 110(0) generates a specified column of the output matrix Y, according to the corresponding transformation control signals. As shown in FIG. 3, after receiving the first input matrix X with the transformation control signal 0, the BOU 110(0) generates the 0th column of the output matrix Y via the DCT procedure. Then, after receiving the input matrix X with the transformation control signal 1, the BOU 110(0) generates the DCT coefficients in the first column of the output matrix Y. Until the BOU 110(0) transforms the input matrix X sequentially into the DCT coefficients in all the columns of the output matrix Y, the output matrix Y is obtained completely.

The requirements on the throughput of DCT operation in different digital image systems are quite different. The throughput of the embodiment in FIG. 3 may be not high enough for some applications requesting higher throughputs. Compared with the prior arts, the present invention has good scalability and can easily raise throughputs simply by increasing the number of BOU based on a required throughput without redesigning the hardware.

Please refer to FIG. 4. In this preferred embodiment, the data processing system 102 includes two BOUs, BOU 110(0) and BOU 110(1). After receiving the input matrix X, the input data control unit 111 outputs the input matrix X for four times to the BOU 110(0). The input data control unit 111 also generates and outputs a transformation control signal to the BOU 110(0) whenever the input matrix X is outputted. The transformation control signals are 0, 2, 4, and 6, respectively.

Whenever the BOU 110(0) receives a transformation control signal from the input data control unit 111, the BOU 110(0) adds one to each transformation control signal (0, 2, 4, and 6) and generates new transformation control signals (1, 3, 5, and 7). The new transformation control signals, together with the input matrix X, are transferred from the BOU 110(0) to the BOU 110(1). Thus, each column of the output matrix Y is assigned to the BOU 110(0) or the BOU 110(1), respectively.

The BOUs 110(0) and 110(1) then perform the basic operation procedure of step S40 on the input matrix X simultaneously. According to the transformation control signals, the BOU 110(0) generates the 0^{th}, 2^{nd}, 4^{th}, and 6^{th} columns in the output matrix Y in sequence, and the BOU 110(1) generates the 1^{st}, 3^{rd}, 5^{th}, and 7^{th} columns in the output matrix Y in sequence. Because the two BOUs 110 perform basic operation procedures in parallel, the data processing system 102 can shorten a lot of time needed by the DCT procedure.

Please refer to FIG. 5. In this preferred embodiment, the data processing system 103 includes eight BOUs, BOU 110(0), 110(1), 110(2), 110(3), 110(4), 110(5), 110(6), and 110(7). After receiving the input matrix X, the input data control unit 111 only needs to output the input matrix X once, and generates a transformation control signal 0 to the BOU 110(0). After that, the BOU 110(0) adds one to the transformation control signal 0 and obtains a new transformation control signal 1 which is then outputted, together with the input matrix X, to the BOU 110(1). The BOU 110(1) also adds one to the transformation control signal 1 and obtains a new transformation control signal 2 which is then outputted, together with the input matrix X, to the BOU 110(2), and so on. Each BOU in the data processing system 103 is appointed to generate a column of the output matrix Y. Thus the complete output matrix Y is obtained by combining the outputs from the BOU 110(0) through the BOU 110(7). The throughput of the DCT procedure of the data processing system 103 is eight times that of the data processing system 101.

In the embodiments of FIG. 4 and FIG. 5, the input data control unit 111 and each of the BOUs 110 are cascaded to each other. In other embodiments, the input data control unit 111 or each of the BOUs 110 is capable of connecting to more than one other BOU 110 at the same time. In those cases, corresponding transformation control signals, together with the input matrix X, are transferred to all the following connected BOUs 110.

The method that each BOU 110 generates the DCT coefficients in a specified column of the output matrix Y is described below. The DCT procedure comprises a first DCT procedure and a second DCT procedure. The first DCT procedure transforms the data x_{k,l} into an intermediate output matrix Z. The intermediate output matrix Z includes a plurality of intermediate output components z_{v,k}. The second DCT procedure then transforms the intermediate output components z_{v,k} into the output matrix Y. The intermediate output components z_{v,k} is represented in the following form:

$$Z = [ \begin{matrix}{z}_{0 , 0} & {z}_{0 , 1} & {z}_{0 , 2} & {z}_{0 , 3} & {z}_{0 , 4} & {z}_{0 , 5} & {z}_{0 , 6} & {z}_{0 , 7} \\ {z}_{1 , 0} & {z}_{1 , 1} & {z}_{1 , 2} & {z}_{1 , 3} & {z}_{1 , 4} & {z}_{1 , 5} & {z}_{1 , 6} & {z}_{1 , 7} \\ {z}_{2 , 0} & {z}_{2 , 1} & {z}_{2 , 2} & {z}_{2 , 3} & {z}_{2 , 4} & {z}_{2 , 5} & {z}_{2 , 6} & {z}_{2 , 7} \\ {z}_{3 , 0} & {z}_{3 , 1} & {z}_{3 , 2} & {z}_{3 , 3} & {z}_{3 , 4} & {z}_{3 , 5} & {z}_{3 , 6} & {z}_{3 , 7} \\ {z}_{4 , 0} & {z}_{4 , 1} & {z}_{4 , 2} & {z}_{4 , 3} & {z}_{4 , 4} & {z}_{4 , 5} & {z}_{4 , 6} & {z}_{4 , 7} \\ {z}_{5 , 0} & {z}_{5 , 1} & {z}_{5 , 2} & {z}_{5 , 3} & {z}_{5 , 4} & {z}_{5 , 5} & {z}_{5 , 6} & {z}_{5 , 7} \\ {z}_{6 , 0} & {z}_{6 , 1} & {z}_{6 , 2} & {z}_{6 , 3} & {z}_{6 , 4} & {z}_{6 , 5} & {z}_{6 , 6} & {z}_{6 , 7} \\ {z}_{7 , 0} & {z}_{7 , 1} & {z}_{7 , 2} & {z}_{7 , 3} & {z}_{7 , 4} & {z}_{7 , 5} & {z}_{7 , 6} & {z}_{7 , 7}\end{matrix} ] .$$

The equation of the first DCT procedure is:

$${z}_{l , h} = {\sum }_{v = 0}^{7} c ( l ) * {x}_{h , v} * COS ( \frac{( 2 v + 1 )}{16} * l * π ) ,$$

wherein

$$c ( 0 ) = \frac{1}{2 \sqrt{2}} , c ( n ) = 1 / 2 ,$$

n is an integer ranging from 1 to 7, and v, h, l are integers ranging from 0 to 7, respectively.

The equation of the second DCT procedure is:

$${y}_{k , l} = {\sum }_{h = 0}^{7} c ( k ) * {z}_{l , h} * COS ( \frac{( 2 h + 1 )}{16} * k * π ) ,$$

wherein

$$c ( 0 ) = \frac{1}{2 \sqrt{2}} , c ( n ) = 1 / 2 ,$$

n is an integer ranging from 1 to 7, and h, l, k are integers, ranging from 0 to 7, respectively.

The first DCT procedure and the second DCT procedure are usually operated in matrix forms. The first DCT procedure transforms the input matrix X into the intermediate output matrix Z with the following matrix operation: Z=C₁X^{t}. The second DCT procedure transforms the intermediate output matrix Z into the output matrix Y in the following matrix form: Y=C₁Z^{t}. X^{t} represents the transpose matrix of the input matrix X, Z^{t} represents the transpose matrix of the intermediate output matrix Z. C₁ represents a transformation matrix in the following form:

$${C}_{1} = [ \begin{matrix}a & a & a & a & a & a & a & a \\ b & d & e & g & - g & - e & - d & - b \\ c & f & - f & - c & - c & - f & f & c \\ d & - g & - b & - e & e & b & g & - d \\ a & - a & - a & a & a & - a & - a & a \\ e & - b & g & d & - d & - g & b & - e \\ f & - c & c & - f & - f & c & - c & f \\ g & - e & d & - b & b & - d & e & - g\end{matrix} ] , [ \begin{matrix}a \\ b \\ c \\ d \\ e \\ f \\ g\end{matrix} ] = \frac{1}{2} [ \begin{matrix}cos \frac{4 π}{16} \\ cos \frac{π}{16} \\ cos \frac{2 π}{16} \\ cos \frac{3 π}{16} \\ cos \frac{5 π}{16} \\ cos \frac{ 6 π}{16} \\ cos \frac{7 π}{16}\end{matrix} ] .$$

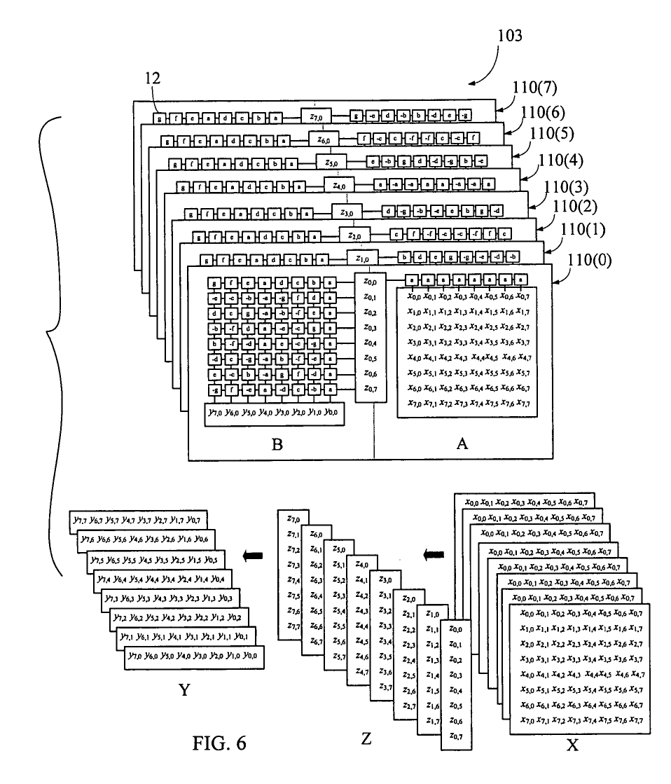

In the following, the embodiment in FIG. 5 is taken as an example to further describe the operation method of the data processing system according to this invention. Please refer to FIG. 6. FIG. 6 shows the operation method of the data processing system 103 shown in FIG. 5. The 8 planes in FIG. 6 represent the 8 BOUs (110(0) through 110(7)) for calculating the 0^{th} column through the 7^{th} column of the output matrix Y, respectively. Part A in FIG. 6 represents the process of transforming the data x_{h,v} into the intermediate output component z_{l,h}. Part B in FIG. 6 represents the process of transforming the intermediate output component z_{l,h} into the discrete cosine transformation coefficient y_{k,l} in the output matrix Y.

Taking the plane 110(0) as an example, please first refer to part A of the plane 110(0). After receiving a transformation control signal, which is 0, and the input matrix X outputted by the input data control unit 111, the BOU 110(0) first operates for the data x_{h,v} of the 0^{th} row in the input matrix X. The BOU 110(0) multiplies each x^{h,v} of the 0^{th} row in the input matrix X by a corresponding transformation coefficients in the matrix C₁ and then sums up the outcomes to obtain the data z_{0,0} of in the 0^{th} row in the intermediate output matrix Z. The operation equation can be represented as:
x_{0,0}*a+x_{0,1}*a+x_{0,2}*a+x_{0,3}*a+x_{0,4}*a+x_{0,5}*a+x_{0,6}*a+x_{0,7}*a=z_{0,0}.

In a similar way, all the data of the 0^{th} row in the intermediate output matrix Z can be obtained sequentially.

In part B of the plane 110(0), the BOU 110(0) first performs the following equation:
z_{0,0}*a+z_{0,1}*a+z_{0,2}*a+z_{0,3}*a+z_{0,4}*a+z_{0,5}*a+z_{0,6}*a+z_{0,7}*a=y_{0,0}.

Thus, the first DCT coefficient y_{0,0} of the 0^{th} column in the output matrix Y is obtained. In the same way, the BOU 110(0) can obtain all the DCT coefficient of the 0^{th} column in the output matrix Y via calculating Y=C₁Z^{t}.

Each of the BOUs 110 receives the data x_{h,v} of the input matrix X and a corresponding transformation control signal in sequence. Following the same procedures, each of the BOUs 110 calculates the DCT coefficients of the 0^{th} to 7^{th} column in the output matrix Y respectively to obtain the output matrix Y completely. Besides, all the planes shown in FIG. 5 operate at the same time.

The digital image codec of the prior art often uses row column decomposition method, which obtains one column of z_{v,k} after inputting one row of x_{h,v} each time. However, to obtain one column of y_{k,l}, one row of z_{l,h} is needed. For example, while the data x_{h,v} of the 0^{th} row is inputted, the prior art generates z_{l,h} of the 0^{th} column with the matrix operation Z=C₁X^{t}. To obtain y_{k,l} of the 0^{th} column, the data z_{l,h} of the 0^{th} row is needed. Therefore, the prior art has to wait until the intermediate output matrix Z in FIG. 5 is obtained completely in the first DCT operation and a buffer memory with high capacity to store the intermediate output matrix Z is needed. Then, the output matrix Y is generated based on the intermediate output matrix Z in the second DCT operation. Moreover, in the prior arts, while the first DCT circuit is working, the second DCT circuit is idle. It not only takes lots of time to compress the image data but also reduces the efficiency of the hardware of the digital image codec. Furthermore, the buffer memory with high capacity increases the cost of the codec.

In contrast, in the data processing system of the present invention, each of the BOUs 110 calculated one row of the intermediate output matrix Z in part A, then directly proceeds to perform the calculation in part B, thus shortening the calculation time of the DCT procedure of the prior art.

The circuit structure and operation method of the BOUs 110 are described in the following. Please refer to FIG. 1. Each of the BOUs 110 includes a first processing unit 120, an intermediate output buffer 130, and a second processing unit 140.

According to one preferred embodiment of this invention, each of the BOUs 110 can further include a continuous control unit 150. The continuous control unit 150 is used for outputting the input matrix X to the continuous control units 150 of the other BOUs 110 and for generating at least one new transformation control signal via the transformation control signal updating procedure.

According to the other preferred embodiment of the present invention (not shown in FIG. 1), the data processing system of the present invention includes at least one input data control unit 111. Each of the input data control units 111 is integrated in each of the BOUs 110 respectively. The function of the input data control unit 111 integrated in the BOU 110 is the same as the continuous control unit 150. Each of the input data control units 111 is used for outputting the input matrix X to the other input data control units 111 and for further generating at least one transformation control signal accompanying the outputting of the input matrix X. For this embodiment, the input data control unit 111 shown in FIG. 1 should be integrated in the BOU 110.

Please refer to the embodiment of FIG. 1. The first processing unit 120 is used for calculating the intermediate output components z_{l,h} of one row in the intermediate output matrix Z with the first DCT procedure and outputting the outcomes to the intermediate output buffer 130. The intermediate output buffer 130 is used for storing the intermediate output components z_{l,h}. While the intermediate output buffer 130 obtains the complete intermediate output components z_{l,h} of one specified row in the intermediate output matrix Z, the intermediate output components z_{l,h} of the row are outputted to the second processing unit 140 to calculate one DCT coefficient of a specified column in the output matrix Y with the second DCT procedure. The operation process of the first processing unit 120 corresponds to the part A in FIG. 6, and the operation process of the second processing unit 140 corresponds to the part B in FIG. 6.

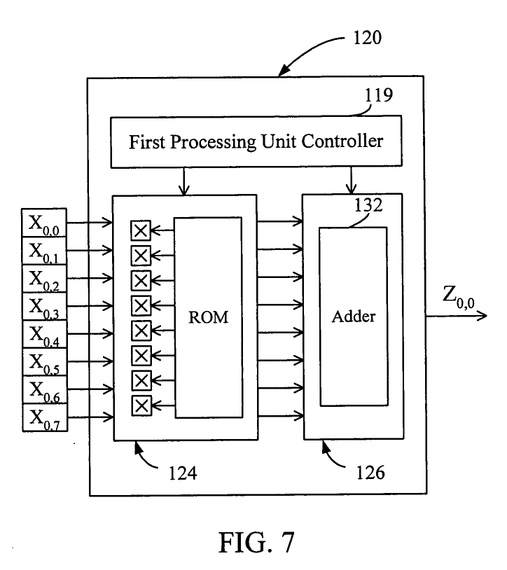

Please refer to FIG. 7. FIG. 7 shows the circuit structure of the first processing unit 120 shown in FIG. 1. The first processing unit 120 includes a first multiplication circuit 124, a first summation circuit 126, and a first processing unit controller 119.

The first multiplication circuit 124 comprises eight multipliers 124A and one ROM 124B. Each multiplier 124A performs a multiplication operation with a transformation coefficient stored in the ROM 124B. The first multiplication circuit 124 is used for multiplying the received data with a set of predetermined transformation coefficients. The transformation coefficients are determined based on the matrix C₁.

There are seven kinds of coefficients in the matrix C₁:

$$\frac{1}{2} cos ( \frac{1}{16} π ) , \frac{1}{2} cos ( \frac{2}{16} π ) , \frac{1}{2} cos ( \frac{3}{16} π ) , \frac{1}{2} cos ( \frac{4}{16} π ) , \frac{1}{2} cos ( \frac{5}{16} π ) , \frac{1}{2} cos ( \frac{6}{16} π ) , \frac{1}{2} cos ( \frac{7}{16} π ) .$$

The seven coefficients can be represented in symbols as:

$$[ \begin{matrix}a \\ b \\ c \\ d \\ e \\ f \\ g\end{matrix} ] = \frac{1}{2} [ \begin{matrix}cos \frac{4 π}{16} \\ cos \frac{π}{16} \\ cos \frac{2 π}{16} \\ cos \frac{3 π}{16} \\ cos \frac{5 π}{16} \\ cos \frac{6 π}{16} \\ cos \frac{7 π}{16}\end{matrix} ] .$$

The first summation circuit 126 is used for summing up the multiplication results generated by the first multiplication circuit 124 to obtain one intermediate output components z_{v,k} of a specified row in the intermediate output matrix Z.

The first processing unit controller 119 is used for controlling the first multiplication circuit 124 and the first summation circuit 126.

The preferred embodiment of FIG. 6 is taken as an example to describe the operation of the first processing unit 120. According to the first DCT procedure, the transformation coefficients corresponding to x_{h,v} of the 0^{th} row are [a a a a a a a a], i.e. the 0^{th} row in C₁. The first processing unit controller 119 transfers x_{k,l} to the corresponding multipliers 125.

After multiplying x_{h,v} by the transformation coefficients, the first processing unit controller 119 controls the first summation circuit 126 to add up all the outputs of the first multiplication circuit 124 for obtaining the intermediate output component z_{0,0} and to output the outcome to the intermediate output buffer 130.

In a similar way, x_{h,v} of the 1^{st} row through x_{h,v} of the 7^{th} row are sequentially inputted to the first processing unit 120 and processed. Thus, all the intermediate output components z_{l,h} of the 0^{th} row in the intermediate output matrix Z can be obtained.

Please refer to FIG. 1. The second processing unit 140 comprises a second multiplication circuit 144, a second summation circuit 146, and a second processing unit controller 149. The second DCT procedure transforms the intermediate output matrix Z into the output matrix Y with the following matrix operation: Y=C₁Z^{t}. The first and the second DCT procedure both use the transformation matrix C₁ and have similar matrix equations. The only difference is that the inputs are different. Accordingly, the functions of the second multiplication circuit 144 and the second summation circuit 146 of the second processing unit 140 are the same as those circuits of the first processing unit 120. The practical circuit structures of the second multiplication circuit 144 and the second summation circuit 146 are not described in detail here.

The preferred embodiment of FIG. 6 is taken as an example to describe the data operation of the second processing unit 140. In the second DCT procedure, the transformation coefficients corresponding to z_{l,h} of the 0^{th} row are [a a a a a a a a] of the 0^{th} row in C₁. After z_{l,h} of the 0^{th} row passes through the multipliers, the outcomes of the multipliers are added up to obtain the corresponding DCT coefficient y_{0,0}. After z_{l,h} of the 0^{th} row completely passes through the operation circuit of the part B in FIG. 6 by repeating the above process for eight times, the 0^{th} column of the output matrix Y is obtained.

According to another preferred embodiment of the present invention, the first and the second DCT procedures are further simplified. The method of the first DCT procedure for generating the intermediate output components z_{l,h} is taken as an example in the following explanation.

The operation process of generating the intermediate output components z_{l,h} can be simplified. The transformation from the x_{h,v} of the 0^{th} row into z_{1,0} is taken as an example. The intermediate output component z_{1,0} is equal to the following equation:
z_{1,0}=x_{0,0}*b+x_{0,1}*d+x_{0,2}*e+x_{0,3}*g+x_{0,4}*(−g)+x_{0,5}*(−e)+x_{0,6}*(−d)+x_{0,7}*(−b).

The equation above can be rewritten as:
z_{1,0}=(x_{0,0}−x_{0,7})*b+(x_{0,1}−x_{0,6})*d+(x_{0,2}−x_{0,5})*e+(x_{0,3}−x_{0,4})*g.

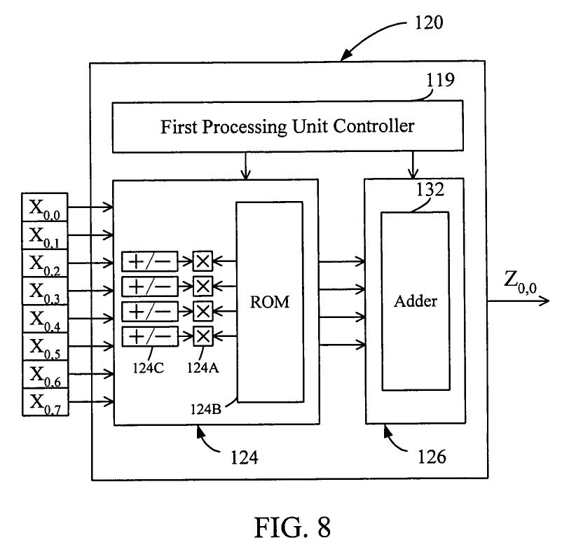

z_{1,0} can be generated by first calculated (x_{0,0}−x_{0,7}), (x_{0,1}−x_{0,6}), (x_{0,2}−x_{0,5}), and (x_{0,3}−x_{0,4}) with four adders/subtractors. Then, the added/subtracted results are respectively multiplied by corresponding transformation coefficients. z_{1,0} is then generated by adding up the multiplication results. Therefore, the original eight multipliers in the first multiplication circuit can be replaced with four adders/subtractors and four multipliers. Please refer to FIG. 8. FIG. 8 shows the first multiplication circuit 120 including four adders/subtractors 124C, four multipliers 124A, and one ROM 124B.

According to the simplification procedure above, if a BOU including eight adders/subtractors and eight multipliers is used, two intermediate output components (for example, z_{0,0} and z_{1,0}) can be simultaneously generated in the BOU. In the same way, the intermediate output components [z_{2,0}z_{3,0}], [z_{4,0} z_{5,0}], and [z_{6,0} z7,0] can also be simultaneously obtained respectively in one BOU.

According to the above simplified process, the matrix C₁ of the first and the second DCT procedures can be simplified as C₁=P₁A₈₈P₂, wherein the matrix A₈₈, the matrix P₁, and the matrix P₂, are represented as follows:

$${A}_{88} = [ \begin{matrix}{A}_{1} & 0 \\ 0 & {A}_{2}\end{matrix} ] , wherein$$

$${A}_{1} = \frac{1}{2} [ \begin{matrix}cos ( \frac{4}{16} π ) & cos ( \frac{4}{16} π ) & cos ( \frac{4}{16} π ) & cos ( \frac{4}{16} π ) \\ cos ( \frac{2}{16} π ) & cos ( \frac{6}{16} π ) & - cos ( \frac{6}{16} π ) & - cos ( \frac{4}{16} π ) \\ cos ( \frac{4}{16} π ) & - cos ( \frac{4}{16} π ) & - cos ( \frac{4}{16} π ) & cos ( \frac{4}{16} π ) \\ cos ( \frac{6}{16} π ) & - cos ( \frac{2}{16} π ) & cos ( \frac{2}{16} π ) & - cos ( \frac{6}{16} π )\end{matrix} ] , and$$

$${A}_{2} = \frac{1}{2} [ \begin{matrix}cos ( \frac{1}{16} π ) & cos ( \frac{3}{16} π ) & cos ( \frac{5}{16} π ) & cos ( \frac{7}{16} π ) \\ cos ( \frac{3}{16} π ) & - cos ( \frac{7}{16} π ) & - cos ( \frac{1}{16} π ) & - cos ( \frac{5}{16} π ) \\ cos ( \frac{5}{16} π ) & - cos ( \frac{1}{16} π ) & cos ( \frac{7}{16} π ) & cos ( \frac{3}{16} π ) \\ cos ( \frac{7}{16} π ) & - cos ( \frac{5}{16} π ) & cos ( \frac{3}{16} π ) & - cos ( \frac{1}{16} π )\end{matrix} ] ;$$

$${P}_{1} = [ \begin{matrix}1 & 0 & 0 & 0 & 0 & 0 & 0 & 1 \\ 0 & 1 & 0 & 0 & 0 & 0 & 1 & 0 \\ 0 & 0 & 1 & 0 & 0 & 1 & 0 & 0 \\ 0 & 0 & 0 & 1 & 1 & 0 & 0 & 0 \\ 1 & 0 & 0 & 0 & 0 & 0 & 0 & - 1 \\ 0 & 1 & 0 & 0 & 0 & 0 & - 1 & 0 \\ 0 & 0 & 1 & 0 & 0 & - 1 & 0 & 0 \\ 0 & 0 & 0 & 1 & - 1 & 0 & 0 & 0\end{matrix} ] , \\ {P}_{2} = [ \begin{matrix}1 & 0 & 0 & 0 & 0 & 0 & 0 & 0 \\ 0 & 0 & 0 & 0 & 1 & 0 & 0 & 0 \\ 0 & 1 & 0 & 0 & 0 & 0 & 0 & 0 \\ 0 & 0 & 0 & 0 & 0 & 1 & 0 & 0 \\ 0 & 0 & 1 & 0 & 0 & 0 & 0 & 0 \\ 0 & 0 & 0 & 0 & 0 & 0 & 1 & 0 \\ 0 & 0 & 0 & 1 & 0 & 0 & 0 & 0 \\ 0 & 0 & 0 & 0 & 0 & 0 & 0 & 1\end{matrix} ] .$$

The matrixes A₁ and A₂ can be rewritten as the following by using the transformation coefficients of the multiplier 125:

$${A}_{1} = [ \begin{matrix}a & a & a & a \\ c & f & - f & - c \\ a & - a & - a & a \\ f & - c & c & - f\end{matrix} ] , {A}_{2} = [ \begin{matrix}b & d & e & g \\ d & - g & - b & - e \\ e & - b & g & d \\ g & - e & d & - b\end{matrix} ] .$$

Because the matrix C₁ is simplified, the first processing unit 110 and the second processing unit 140 of the BOU 110 of the present invention can be simplified accordingly.

The data processing system and method thereof according to this invention are not limited in 8-8 DCT procedures. The data processing system and method thereof can also be applied in DCT procedures with different dimensions, for example, 4-4 DCT procedures, 4-8 DCT procedures, or 8-4 DCT procedures.

The present invention provides a data processing system and method thereof for performing DCT procedures. The data processing method includes first generating a transformation control signal and transferring the transformation control signal together with the input matrix to at least one BOU. By a transformation control signal updating procedure, a new transformation control signal is generated according to the received transformation control signal received by the corresponding BOU, and transferred together with the input matrix to the other following BOUs. The step of generating new transformation control signals is repeated until each column of the output matrix is assigned to a corresponding BOU. Finally, a basic operation procedure is performed in the BOUs, and the input matrix is transformed to the output matrix according to the transformation control signals.

With the method of the present invention, the present invention can solve the problem that the data processing systems of prior arts are not scalable. According to different requirements on the throughput of DCT procedures in different systems, the present invention can integrate a plurality of BOUs, without redesigning the hardware. In the present invention, a plurality of BOUs can be enabled to perform DCT procedures at the same time, thus the total time of calculation is shorten. The present invention also solves the problem in prior arts that the second DCT procedure is idle for waiting the results of the first DCT procedure. The present invention can reduce the capacity requirement for the buffer memory of prior arts, too. Furthermore, the present invention can decrease the operation time and the necessary hardware circuit by sharing operation procedure; hence image processing time and the cost of hardware are both substantially reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system for transforming one input matrix X having a plurality of data into discrete cosine transform (DCT) coefficients in a plurality of specified columns in an output matrix Y via a DCT procedure, the data processing system comprising:
at least one input data control unit, each of the input data control units being for outputting the input matrix X to at least one of the other input data control units, and for further generating at least one transformation control signal together with each outputting of the input matrix X, the transformation control signal indicating the at least one specified column in the output matrix Y to be generated after the input matrix X is transformed via the DCT procedure, wherein after receiving the transformation control signal from another input data control unit, each of the input data control units generates a corresponding new transformation control signal according to the received transformation control signal; and
at least one basic operation unit (BOU), each BOU being for receiving the input matrix X and the transformation control signal outputted from one corresponding input data control unit among the input data control units, and for decoding the received input matrix X according to the transformation control signal and obtaining the DCT coefficients in said at least one specified column in the output matrix Y

2. The data processing system of claim 1, wherein the input data control units are integrated in the BOUs.

3. The data processing system of claim 2, wherein the BOUs are cascaded with each other.

4. The data processing system of claim 3, wherein each of the BOUs is capable of connecting to more than one of the other BOUs at the same time.

5. The data processing system of claim 1, wherein the DCT procedure comprises a first DCT procedure and a second DCT procedure.

6. The data processing system of claim 5, wherein the DCT procedure is an 8-8 DCT procedure, the input matrix has 8 rows and 8 columns of data (x_{h,v}), the first DCT procedure transforms the data (x_{h,v}) into a plurality of intermediate output components (z_{l,h}) of an intermediate output matrix, the equation of the first DCT procedure is:
$${z}_{l , h} = {\sum }_{v = 0}^{7} c ( l ) * {x}_{h , v} * COS ( \frac{( 2 v + 1 )}{16} * l * π ) ,$$
wherein
$$c ( 0 ) = \frac{1}{2 \sqrt{2}} , c ( n ) = 1 / 2 ,$$
n is an integer ranging from 1 to 7, v, h, l are integers ranging from 0 to 7, respectively,
the second DCT procedure transforms the intermediate output components into the output matrix having 8 rows and 8 columns of DCT coefficients (y_{k,l}), and the equation of the second DCT procedure is:
$${y}_{k , l} = {\sum }_{h = 0}^{7} c ( k ) * {z}_{l , h} * COS ( \frac{( 2 h + 1 )}{16} * k * π ) ,$$
wherein
$$c ( 0 ) = \frac{1}{2 \sqrt{2}} , c ( n ) = 1 / 2 ,$$
n is an integer ranging from 1 to 7, and h, l, k are integers, ranging from 0 to 7, respectively.

7. The data processing system of claim 6, wherein the first DCT procedure transforms the input matrix X into the intermediate output matrix Z with the following matrix operation: Z=C₁X^{t}, the second DCT procedure transforms the intermediate output matrix Z into the output matrix Y with the following matrix operation: Y=CZ^{t}, wherein X^{t} represents the transpose matrix of the input matrix X, Z^{t} represents the transpose matrix of the intermediate output matrix Z, and C₁ represents a transformation matrix in the following form:
$${C}_{1} = [ \begin{matrix}a & a & a & a & a & a & a & a \\ b & d & e & g & - g & - e & - d & - b \\ c & f & - f & - c & - c & - f & f & c \\ d & - g & - b & - e & e & g & b & - d \\ a & - a & - a & a & a & - a & - a & a \\ e & - b & g & d & - d & - g & b & - e \\ f & - c & c & - f & - f & c & - c & f \\ g & - e & d & - b & b & - d & e & - g\end{matrix} ] , [ \begin{matrix}a \\ b \\ c \\ d \\ e \\ f \\ g\end{matrix} ] = \frac{1}{2} [ \begin{matrix}cos \frac{4 π}{16} \\ cos \frac{π}{16} \\ cos \frac{2 π}{16} \\ cos \frac{3 π}{16} \\ cos \frac{5 π}{16} \\ cos \frac{6 π}{16} \\ cos \frac{7 π}{16}\end{matrix} ] .$$

8. The data processing system of claim 7, wherein C₁ is expressed as C₁=P₁A₈₈P₂, and
$${A}_{88} = [ \begin{matrix}{A}_{1} & 0 \\ 0 & {A}_{2}\end{matrix} ] , \\ {A}_{1} = \frac{1}{2} [ \begin{matrix}cos ( \frac{4}{16} π ) & cos ( \frac{4}{16} π ) & cos ( \frac{4}{16} π ) & cos ( \frac{4}{16} π ) \\ cos ( \frac{2}{16} π ) & cos ( \frac{6}{16} π ) & - cos ( \frac{6}{16} π ) & - cos ( \frac{4}{16} π ) \\ cos ( \frac{4}{16} π ) & - cos ( \frac{4}{16} π ) & - cos ( \frac{4}{16} π ) & cos ( \frac{4}{16} π ) \\ cos ( \frac{6}{16} π ) & - cos ( \frac{2}{16} π ) & cos ( \frac{2}{16} π ) & - cos ( \frac{6}{16} π )\end{matrix} ] , \\ {A}_{2} = \frac{1}{2} [ \begin{matrix}cos ( \frac{1}{16} π ) & cos ( \frac{3}{16} π ) & cos ( \frac{5}{16} π ) & cos ( \frac{7}{16} π ) \\ cos ( \frac{3}{16} π ) & - cos ( \frac{7}{16} π ) & - cos ( \frac{1}{16} π ) & - cos ( \frac{5}{16} π ) \\ cos ( \frac{5}{16} π ) & - cos ( \frac{1}{16} π ) & cos ( \frac{7}{16} π ) & cos ( \frac{3}{16} π ) \\ cos ( \frac{7}{16} π ) & - cos ( \frac{5}{16} π ) & cos ( \frac{3}{16} π ) & - cos ( \frac{1}{16} π )\end{matrix} ] , \\ {P}_{1} = [ \begin{matrix}1 & 0 & 0 & 0 & & 0 & 0 & 0 & 1 \\ 0 & 1 & 0 & 0 & & 0 & 0 & 1 & 0 \\ 0 & 0 & 1 & 0 & & 0 & 1 & 0 & 0 \\ 0 & 0 & 0 & 1 & & 1 & 0 & 0 & 0 \\ 1 & 0 & 0 & 0 & & 0 & 0 & 0 & - 1 \\ 0 & 1 & 0 & 0 & & 0 & 0 & - 1 & 0 \\ 0 & 0 & 1 & 0 & & 0 & - 1 & 0 & 0 \\ 0 & 0 & 0 & 1 & & - 1 & 0 & 0 & 0\end{matrix} ] , and$$
$${P}_{2} = [ \begin{matrix}1 & 0 & 0 & 0 & 0 & 0 & 0 & 0 \\ 0 & 0 & 0 & 0 & 1 & 0 & 0 & 0 \\ 0 & 1 & 0 & 0 & 0 & 0 & 0 & 0 \\ 0 & 0 & 0 & 0 & 0 & 1 & 0 & 0 \\ 0 & 0 & 1 & 0 & 0 & 0 & 0 & 0 \\ 0 & 0 & 0 & 0 & 0 & 0 & 1 & 0 \\ 0 & 0 & 0 & 1 & 0 & 0 & 0 & 0 \\ 0 & 0 & 0 & 0 & 0 & 0 & 0 & 1\end{matrix} ] .$$

9. The data processing system of claim 8, wherein each of the BOUs further comprises:
a first processing unit for sequentially obtaining the intermediate output components (z_{l,h}) in said at least one specified row of the intermediate output matrix Z via the first DCT procedure and based on the data (x_{h,v}) in the input matrix X;
an intermediate output buffer for storing the intermediate output components generated by the first processing unit; and
a second processing unit for accessing the intermediate output components stored in the intermediate output buffer and calculating the DCT coefficients in said at least one specified column via the second DCT procedure.

10. The data processing system of claim 9, wherein the first processing unit sequentially generates the intermediate output components (z_{l,h}) in said at least one specified row of the intermediate output matrix Z and outputs the outcome to the intermediate output buffer, and while the complete intermediate output components in the corresponding at least one specified row of the intermediate output matrix are obtained, the complete intermediate output components are outputted to the second processing unit to obtain the complete DCT coefficients (y_{k,l}) in the corresponding at least one specified column of the output matrix Y.

11. The data processing system of claim 10, wherein the first processing unit comprises:
a first multiplication circuit for multiplying each data of the row, which corresponds to the transformation control signal, in the input matrix X by a respective transformation coefficient in a first set of transformation coefficients to obtain a plurality of multiplication products;
a first summation circuit for summing up the multiplication products obtained by the first multiplication circuit to obtain the intermediate output components in said at least one specified row of the intermediate output matrix; and
a first controlling unit for controlling the first multiplication circuit and the first summation circuit.

12. The data processing system of claim 11, wherein the first multiplication circuit comprises eight multipliers and a ROM for storing the first set of transformation coefficients.

13. The data processing system of claim 11, wherein the first multiplication circuit comprises four adders/subtractors, four multipliers and a ROM for storing the first set of transformation coefficients.

14. The data processing system of claim 10, wherein the second processing unit comprises:
a second multiplication circuit for multiplying each intermediate output component of the row, which corresponds to the transformation control signal, in the intermediate output matrix Z by a respective transformation coefficient in a second set of transformation coefficients to obtain a plurality of multiplication products;
a second summation circuit for summing up the multiplication products obtained by the second multiplication circuit to obtain one DCT coefficient in said at least one specified column in the output matrix Y; and
a second controlling unit for controlling the second multiplication circuit and the second summation circuit.

15. The data processing system of claim 14, wherein the second multiplication circuit comprises eight multipliers and a ROM for storing a first set of transformation coefficients.

16. The data processing system of claim 14, wherein the second multiplication circuit comprises four adders/subtractors, four multipliers and a ROM for storing the first set of transformation coefficients.

17. A data processing system for transforming one input matrix X having a plurality of data into discrete cosine transform (DCT) coefficients in a plurality of specified columns in an output matrix Y via a DCT procedure, the data processing system comprising:
an input data control unit for outputting the input matrix X, and for further generating at least one transformation control signal together with each outputting of the input matrix X, the at least one transformation control signal indicating the at least one specified decoded column in the output matrix Y respectively after the input matrix X is transformed via the DCT procedure; and
at least one BOU, each BOU being cascaded with each other, one of the BOUs receiving the input matrix X and the transformation control signal outputted from the input data control unit, and outputting at least one new transformation control signal generated based on the received transformation control signal, together with the input matrix to the following BOU, the other BOUs receiving the input matrix X and the transformation control signal outputted from one BOU and outputting at least one new transformation control signal generated based on the received transformation control signal, together with the input matrix to the following BOU, each of the BOUs decoding the received input matrix X according to the received transformation control signal and obtaining the data in said at least one specified column in the output matrix Y.

18. The data processing system of claim 17, wherein the BOUs are cascaded with each other.

19. The data processing system of claim 18, wherein each of the BOUs is capable of connecting to more than one of the other BOUs at the same time.

20. An input data control method for a data processing system, the data processing system comprising at least one BOU, each of the BOUs being cascaded with each other, the data processing system being for transforming one input matrix X having a plurality of data into discrete cosine transform (DCT) coefficients in a plurality of specified columns in an output matrix Y via a DCT procedure, the input data control method comprising:
(a) generating a transformation control signal, outputting the transformation control signal together with the input matrix to at least one of the BOUs, the transformation control signal indicating the at least one first specified column in the output matrix Y to be generated after the input matrix X is transformed via the DCT procedure;
(b) performing a transformation control signal update procedure, outputting a new transformation control signal generated according to the received transformation control signal, together with the input matrix X, to the other following BOU, the new transformation control signal indicating the at least one second specified column in the output matrix Y to be generated after the input matrix X is transformed via the DCT procedure, the second specified column being different from the first specified column;
(c) repeating step (b) until each column of the output matrix Y is appointed to be generated by a corresponding BOU; and
(d) performing a basic operation procedure, decoding the received input matrix according to the received transformation control signal to obtain the data in the specified columns corresponding to the transformation control signal.

21. The input data control method of claim 20, wherein the transform control signal is the first column number of said at least one specified column in the output matrix Y after the input matrix X is transformed and decoded via the DCT procedure.

22. The input data control method of claim 21, wherein the transform control signal update procedure comprises:
receiving the transform control signal; and
adding one to the first column number of the at least one specified column to obtain the new transform control signal.

23. The input data control method of claim 20, wherein the DCT procedure comprises a first DCT procedure and a second DCT procedure.

24. The input data control method of claim 23, wherein the DCT procedure is an 8-8 DCT procedure, the input matrix has 8 rows and 8 columns of data (x_{h,v}), the first DCT procedure transforms the data (x_{h,v}) into a plurality of intermediate output components (z_{l,h}) of an intermediate output matrix, the equation of the first DCT procedure is:
$${z}_{l , h} = {\sum }_{v = 0}^{7} c ( l ) * {x}_{h , v} * COS ( \frac{( 2 v + 1 )}{16} * l * π ) ,$$
wherein
$$c ( 0 ) = \frac{1}{2 \sqrt{2}} , c ( n ) = 1 / 2 ,$$
n is an integer ranging from 1 to 7, v, h, l are integers ranging from 0 to 7, respectively,
the second DCT procedure transforms the intermediate output components into the output matrix having 8 rows and 8 columns of DCT coefficients (y_{k,l}), and the equation of the second DCT procedure is:
$${y}_{k , l} = {\sum }_{h = 0}^{7} c ( k ) * {z}_{l , h} * COS ( \frac{( 2 h + 1 )}{16} * k * π ) ,$$
wherein
$$c ( 0 ) = \frac{1}{2 \sqrt{2}} , c ( n ) = 1 / 2 ,$$
n is an integer ranging from 1 to 7, and h, l, k are integers, ranging from 0 to 7, respectively.

25. The input data control method of claim 24, wherein the basic operation procedure comprises:
based on the input matrix X, generating the intermediate output components in at least one specified row in the intermediate output matrix Z via the first DCT procedure; and
based on the generated intermediate output components, calculating the DCT coefficients in at least one specified column in the output matrix via the second DCT procedure.

26. A BOU for a data processing system, the data processing system being for transforming one input matrix X having a plurality of data into one intermediate output matrix having a plurality of intermediate output components via a first discrete cosine transform (DCT) procedure and transforming the intermediate output matrix into DCT coefficients in a plurality of specified columns in a output matrix via a second DCT procedure, the BOU comprising:
a first processing unit for sequentially obtaining the intermediate output components (z_{l,h}) in said at least one specified row of the intermediate output matrix Z via the first DCT procedure and based on the data (x_{h,v}) in the input matrix X;
an intermediate output buffer for storing the intermediate output components generated by the first processing unit; and
a second processing unit for accessing the intermediate output components stored in the intermediate output buffer and calculating the DCT coefficients in said at least one specified column via the second DCT procedure.

27. The BOU of claim 26, wherein the first processing unit sequentially generates the intermediate output components (z_{l,h}) in said at least one specified row of the intermediate output matrix Z and outputs the outcome to the intermediate output buffer, and while the complete intermediate output components in the corresponding at least one specified row of the intermediate output matrix are obtained, the complete intermediate output components are outputted to the second processing unit to obtain the complete DCT coefficients (y_{k,l}) in the corresponding at least one specified column of the output matrix Y

28. The BOU of claim 27, wherein the DCT procedure is an 8-8 DCT procedure, the input matrix has 8 rows and 8 columns of data (x_{h,v}), the first DCT procedure transforms the data (x_{h,v}) into a plurality of intermediate output components (z_{l,h}) of an intermediate output matrix, the equation of the first DCT procedure is:
$${z}_{l , h} = {\sum }_{v = 0}^{7} c ( l ) * {x}_{h , v} * COS ( \frac{( 2 v + 1 )}{16} * l * π ) ,$$
wherein
$$c ( 0 ) = \frac{1}{2 \sqrt{2}} , c ( n ) = 1 / 2 ,$$
n is an integer ranging from 1 to 7, v, h, l are integers ranging from 0 to 7, respectively,
the second DCT procedure transforms the intermediate output components into the output matrix having 8 rows and 8 columns of DCT coefficients (y_{k,l}), and the equation of the second DCT procedure is:
$${y}_{k , l} = {\sum }_{h = 0}^{7} c ( k ) * {z}_{l , h} * COS ( \frac{( 2 h + 1 )}{16} * k * π ) ,$$
wherein
$$c ( 0 ) = \frac{1}{2 \sqrt{2}} , c ( n ) = 1 / 2 ,$$
n is an integer ranging from 1 to 7, and h, l, k are integers, ranging from 0 to 7, respectively.

29. The BOU of claim 28, wherein the first processing unit further comprises:
a first multiplication circuit for multiplying each data of the row, which corresponds to the transformation control signal, in the input matrix X by a respective transformation coefficient in a first set of transformation coefficients to obtain a plurality of multiplication products;
a first summation circuit for summing up the multiplication products obtained by the first multiplication circuit to obtain the intermediate output components in said at least one specified row of the intermediate output matrix; and
a first controlling unit for controlling the first multiplication circuit and the first summation circuit.

30. The BOU of claim 29, wherein the first multiplication circuit comprises eight multipliers and a ROM for storing the first set of transformation coefficients.

31. The BOU of claim 29, wherein first multiplication circuit comprises four adders/subtractors, four multipliers and a ROM for storing the first set of transformation coefficients.

32. The BOU of claim 28, wherein the second processing unit comprises:
a second multiplication circuit for multiplying each intermediate output component of the row, which corresponds to the transformation control signal, in the intermediate output matrix Z by a respective transformation coefficient in a second set of transformation coefficients to obtain a plurality of multiplication products;
a second summation circuit for summing up the multiplication products obtained by the second multiplication circuit to obtain one DCT coefficient in said at least one specified column in the output matrix Y; and
a second controlling unit for controlling the second multiplication circuit and the second summation circuit.

33. The BOU of claim 32, wherein the second multiplication circuit comprises eight multipliers and a ROM for storing a first set of transformation coefficients.

34. The BOU of claim 32, wherein the second multiplication circuit comprises four adders/subtractors, four multipliers and a ROM for storing the first set of transformation coefficients.

35. The BOU of claim 26, further comprises a continuous control unit, wherein each of the continuous control units is for outputting the input matrix X to at least one of the other BOU's continuous control unit, and for further generating at least one transform control signal together with each outputting of the input matrix X, the transform control signal indicating the at least one specified column in the output matrix Y to be generated after the input matrix X is transformed via the DCT procedure, wherein after receiving the transform control signal from another continuous control unit, each of the continuous control units generates a corresponding new transform control signal according to the received transform control signal.
